(19) United States
(12) Patent Application Publication
(10) Pub. No.: US 2009/0306260 A1
(43) Pub. Date: Dec. 10, 2009

(54) Organized Layered Silicate And Method For Producing Same, Resin Composition

(75) Inventor: Takayoshi Kuwabara, Fujinomiya-shi (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/159,600

(22) PCT Filed: Dec. 20, 2006
(86) PCT No.: PCT/JP2006/325433

§ 371 Date: Jun. 3, 2009

(30) Foreign Application Priority Data
Dec. 28, 2005 (JP) 2005-377773

(51) Int. Cl. C08K 5/5415; B32B 5/16; C07F 7/02

(52) U.S. Cl. 524/261; 428/402; 556/463

(57) ABSTRACT

An organically modified layered silicate including a laminate composed of 3 to 60 layers of silicate that have been treated with a surface treatment agent in a dispersed state, wherein the laminate has a thickness of 10 nm to 120 nm, and an interlayer distance of the layers of the surface-treated silicate constituting the laminate is 1.5 nm to 4.0 nm. A preferred aspect of the present invention is an organically modified layered silicate obtained by dispersing layered silicate in a solvent to prepare a dispersion liquid, adding a surface treatment agent into the dispersion liquid until the pH of the dispersion liquid reaches 5 to 7 to obtain an organically modified layered silicate dispersion liquid, filtering the layered silicate dispersion liquid to obtain an organically modified layered silicate, and washing the organically modified layered silicate.

### TECHNICAL FIELD

The present invention relates to organically modified layered silicate and a method for producing an organically modified layered silicate, as well as a resin composition containing the organically modified layered silicate.

### BACKGROUND ART

Conventionally, when anisotropic inorganic fine particles, such as layered silicate having a large aspect ratio, is subjected to a surface treatment with a surface treatment agent or the like and added in a thermoplastic resin, the utilization of the anisotropy of the obtained composition makes it possible to provide the thermoplastic resin with functions such as mechanical strength and heat resistance, and such compositions are used as viscosity adjustors for cosmetics, coating compositions, oils and fats, and the like.

For such organically modified layered silicate, those in which quaternary ammonium ions are introduced between layers thereof are mostly used. As the layered silicate, freely expandable layered silicate into which organic molecules having a high molecular weight can be easily incorporated is used (see Patent Literature 1). The reason is considered that the freely expandable layered silicate has such a property that it incorporates, in water, water molecules in its layers to greatly widen a space between the layers thereof and become dissociated into substantially one layer, which is a basic unit of silicate particles, and thus organic molecules having a high-molecular weight are easily intercalated between the layers.

However, when expandable layered silicate is organically modified and the expandable layered silicate itself is not uniformly dispersed in a solvent such as water, a large amount of high-density aggregates of particles are formed upon a reaction with organic cations. Therefore, there is a problem that salts produced as by-products cannot be efficiently removed by washing. Further, when a layered silicate dispersion liquid is dried and then added in a matrix such as a thermoplastic resin, the dispersion size of aggregates of particles formed cannot be reduced and a uniform dispersion state cannot be achieved, resulting in degradation in efficiency of mechanical physical properties and gas barrier property.

Conventionally, physical properties of organically modified layered silicate such as mechanical strength, gas barrier property and dimensional stability have been greatly improved by dispersing silicate so as to have a thickness and a size as dose to those of one by one layer as possible. However, it is necessary to change the type of surface treatment agent and the type of layered silicate used depending on the type of resin used in which organically modified layered silicate is dispersed as well as on the desired physical properties. There are infinite combinations of a surface treatment agent and a layered silicate, and organically modified layered silicate have not yet reached a level where it is completely dispersed into one by one layer. However, when organically modified layered silicate is merely dispersed into one by one layer, physical properties thereof may be adversely degraded. It is considered that there exists an optimum thickness and an optimum size in practical use, however, this point has not been sufficiently examined in the past.

In order to solve the problem, for example, a method is proposed in which expandable layered silicate is freeze-dried to retain a dispersed state at the time of suspension, the finely dispersed layered silicate is subjected to a plasma treatment to react with an organic compound to the extent of a layer surface and surfaces of the interlayer layers to thereby prevent secondary aggregation of the expandable layered silicate (see Patent Literature 2).

However, the proposed method also has a shortcoming in that when layered silicate whose surface has not been treated with an organic compound is suspended in water, it is impossible to retain a dispersed state where layers are completely separated to each other even when frozen and dried.

Patent Literature 1: Japanese Patent Application Laid-Open (JP-A) No. 2004-91262

Patent Literature 2: Japanese Patent (JP-B) No. 2636204

### DISCLOSURE OF INVENTION

An object of the present invention is to provide organically modified layered silicate that can prevent aggregation of organically modified layered silicate caused when expandable silicate is organically modified as well as can reduce the dispersion size of aggregates of particles caused when the organically modified layered silicate is added in a thermoplastic resin or the like, a method for producing an organically modified layered silicate, and a resin composition containing the organically modified layered silicate of which the mechanical strength, dimensional stability, optical transparency, and gas barrier property thereof are improved in balance.

### MEANS FOR SOLVING THE PROBLEMS ARE AS FOLLOWS

<1> An organically modified layered silicate including:

a laminate composed of 3 to 60 layers of silicate that have been treated with a surface treatment agent in a dispersed state,

wherein the laminate has a thickness of 10 nm to 120 nm, and an interlayer distance of the layers of the surface-treated silicate constituting the laminate is 1.5 nm to 4.0 nm.

<2> The organically modified layered silicate according to the item <1>, wherein the average particle diameter of the laminate in a dispersed state is 0.01 μm to 30 μm.

<3> The organically modified layered silicate according to any one of the items <1> and <2>, wherein the organically modified layered silicate is obtained by dispersing a layered silicate in a solvent to prepare a dispersion liquid, adding a surface treatment agent into the dispersion liquid until the pH of the dispersion liquid reaches 5 to 7 to obtain an organically modified layered silicate dispersion liquid, filtering the layered silicate dispersion liquid to obtain an organically modified layered silicate, and washing the organically modified layered silicate.

<4> The organically modified layered silicate according to any one of the items <1> to <3>, wherein the surface treatment agent is any one of an organophosphonium compound and an organoimidazolium compound.

<5> A method for producing an organically modified layered silicate including:

dispersing a layered silicate in a solvent to prepare a dispersion liquid,

adding a surface treatment agent into the dispersion liquid until the pH of the dispersion liquid reaches 5 to 7 to obtain an organically modified layered silicate dispersion liquid,

filtering the layered silicate dispersion liquid to obtain an organically modified layered silicate, and

washing the organically modified layered silicate.

<6> The method for producing an organically modified layered silicate according to the item <5>, further including:

drying the organically modified layered silicate after the filtration and washing.

<7> The method for producing an organically modified layered silicate according to the item <5>, further including:

freeze-drying the organically modified layered silicate in vacuo at a temperature of −30° C. or lower after the washing.

<8> A resin composition including:

a thermoplastic resin, and

the organically modified layered silicate according to any one of <1> to <4>.

<9> The resin composition according to the item <8>, wherein the thermoplastic resin is at least one selected from polyethylene terephthalate, polyethylene naphthalate, polycarbonate, polymethylmethacrylate, and polyethylene terephthalate obtained by copolymerization of a monomer having as a substituent at least any one of an amide group and a sulfonate group.

An organically modified layered silicate according to the present invention contains a laminate composed of 3 to 60 layers of silicate that have been treated with a surface treatment agent in a dispersed state, wherein the laminate has a thickness of 10 nm to 120 nm, and an interlayer distance of the layers of the surface-treated silicate constituting the laminate is 1.5 nm to 4.0 nm. Therefore, when the organically modified layered silicate is added in a thermoplastic resin, a resin composition containing the organically modified layered silicate can be obtained, in which the dispersion size of aggregates of particles is reduced, and the mechanical strength, dimensional stability, optical transparency, and gas barrier property thereof are improved in balance

In a method for producing an organically modified layered silicate according to the present invention, a layered silicate is dispersed in a solvent to prepare a dispersion, a surface treatment agent is added into the dispersion liquid until the pH of the dispersion liquid reaches 5 to 7 to obtain an organically modified layered silicate dispersion liquid, the organically modified layered silicate dispersion is filtrated to obtain organically modified layered silicate, and the organically modified layered silicate is washed. As a result, it is possible to prevent aggregates of organically modified layered silicate caused when expandable silicate is organically modified.

A resin composition according to the present invention contains a thermoplastic resin and an organically modified layered silicate of the present invention, and thus the resin composition has excellent mechanical strength, dimensional stability, optical transparency and gas barrier property, and can be suitably used in various molded articles, optical films, optical sheets, magnetic material supports, and supports for image forming materials.

### BEST MODE FOR CARRYING OUT THE INVENTION

### Organically Modified Layered Silicate and Method for Producing Organically Modified Layered Silicate

An organically modified layered silicate according to the present invention contains a laminate composed of the predetermined number of layers of silicate that have been treated with a surface treatment agent in a dispersed state, the laminate has a certain thickness, and there exists a predetermined gap (a predetermined interlayer distance) between each of surface-treated silicate layers constituting the laminate.

A method for producing an organically modified layered silicate according to the present invention includes dispersing a layered silicate in a solvent to prepare a dispersion liquid, adding a surface treatment agent into the dispersion liquid until the pH of the dispersion liquid reaches 5 to 7 to obtain an organically modified layered silicate dispersion liquid, filtering the layered silicate dispersion liquid to obtain an organically modified layered silicate, and washing the organically modified layered silicate.

When the method for producing an organically modified layered silicate of the present invention is carried out, an organically modified layered silicate according to the present invention can be produced.

Hereinafter, the organically modified layered silicate of the present invention and the method for producing an organically modified layered silicate of the present invention will be described in detail.

The organically modified layered silicate of the present invention contains a laminate composed of 3 to 60 layers of silicate that have been treated with a surface treatment agent in a dispersed state, wherein the laminate has a thickness of 10 nm to 120 nm, and an interlayer distance of the layers of the surface-treated silicate constituting the laminate is 1.5 nm to 4.0 nm. In particular, the organically modified layered silicate preferably contains a laminate composed of 10 to 50 layers of silicate that have been treated with a surface treatment agent. The laminate preferably has a thickness of 30 nm to 100 nm, and the interlayer distance between each of the surface-treated silicate layers constituting the laminate is preferably 2.0 nm to 3.5 nm.

Further, the average particle diameter of the organically modified layered silicate composed of a laminate in a dispersed state is preferably 0.01 μm to 30 μm, more preferably 0.05 μm to 20 μm, and still more preferably 0.1 μm to 20 μm.

Here, the average particle diameter can be determined, for example, by cutting out a film obtained from the organically modified layered silicate that is composed of a silicate in a dispersed state, in cross section using a microtome, observing the cross section by an electron microscope to measure particle diameters of a number of particles and averaging out the measured particle diameters.

When the organically modified layered silicate is provided with the characteristics of the laminate and the average particle diameter in a dispersed state, for example, in a state of being dispersed in a resin, the mechanical strength, dimensional stability, optical transparency and gas barrier property of the organically modified layered silicate can be improved in balance.

The dispersed state is not particularly limited, as long as the organically modified layered silicate is dispersed so as to satisfy the ranges of the characteristics. The organically modified layered silicate may be dispersed in a solvent or in a resin.

Examples of the solvent include water, acetone, methyl alcohol, ethyl alcohol, isopropyl alcohol, and tetrahydrofuran (THF). These may be used alone or in combination.

Examples of the resin include polyethylene terephthalate, polyethylene naphthalate, polycarbonate, polymethylmethacrylate, and polyethylene terephthalate obtained by copolymerization of a monomer having as a substituent at least any one of an amide group and a sulfonate group. These may be used alone or in combination.

The characteristics of the organically modified layered silicate can be quantified, when the organically modified layered silicate is formed in a film, from a planar direction of the film by image analysis. From a cross-sectional direction, the characteristics can be quantified by an electron microscope or a transmission electron microscope. Further, when the organically modified layered silicate is in a solution, the characteristics can be quantified by laser scattering or dynamic light scattering.

The organically modified layered silicate can be obtained by dispersing a layered silicate in a solvent to prepare a dispersion liquid, adding a surface treatment agent into the dispersion liquid until the pH of the dispersion liquid reaches 5 to 7 to obtain an organically modified layered silicate dispersion liquid, filtering the layered silicate dispersion liquid to obtain an organically modified layered silicate, and washing the organically modified layered silicate. In this case, it is preferable that the organically modified layered silicate be dried after the filtration and washing.

### —Layered Silicate—

The layered silicate is not particularly limited, and can be appropriately selected depending on the purpose; examples thereof include smectite clay minerals such as natural or synthetic hectorite, saponite, stevensite, beidellite, montmorillonite, nontronite, and bentonite; expandable mica clay minerals such as Na-type tetrasilisic fluorine mica, Li-type tetrasilisic fluorine mica, Na-type fluorine teniolite, and Li-type fluorine teniolite; and vermiculite. These may be used alone or in combination. Among these, expandable micas and smectites are preferable in terms that they are easily dissolved, expanded and dispersed in a solvent and easily surface-treated with a surface treatment agent.

As the layered silicate, a suitably synthesized one or a commercially available one may be used. Examples of the commercially available product include, LAPONITE XLG (synthetic hectorite analogue, manufactured by Laporte Corp. in U.K.), LAPONITE RD (synthetic hectorite analogue, manufactured by Laporte Corp. in U.K.), THERMABIS (synthetic hectorite analogue, manufactured by Henkel Corp. in Germany), SMECTONE SA-1 (saponite analogue, manufactured by Kunimine Industries Co., Ltd.), BENGEL (natural montmorillonite, supplied by Hojun Yoko Co. Ltd.), KUNIPIA F (natural montmorillonite, supplied by Kunimine Industries Co., Ltd.), BEEGUM (natural hectorite, manufactured by Vanderbilt Corp. in U.S.A.), DIMONITE (synthetic expandable mica, manufactured by Topy Industry, Ltd.), SOMASIF (synthetic expandable mica, manufactured by CO-OP Chemical Co., Ltd.), LUCENTITE SWN (synthetic smectite, manufactured by CO-OP Chemical Co., Ltd.), and LUCENTITE SWF (synthetic smectite, manufactured by CO-OP Chemical Co., Ltd.).

The word “expandable” means the characteristic observed when a solvent such as water, alcohol, and ether infiltrates into layers of layered silicate and the layered silicate is expanded.

### —Surface Treatment Agent—

The surface treatment agent is not particularly limited and can be appropriately selected depending on the purpose; examples thereof include organoonium compounds, organohydroxy compounds, organosilane compounds, organohalogen compounds, epoxy group-containing compounds, and imidazolium group-containing compounds. These may be used alone or in combination. Among these, organoonium compounds are particularly preferable.

Examples of the organoonium compound include organoammonium compounds, organophosphonium compounds, organosulfonium compounds and organoimidazolium compounds. Among these, organoammonium compounds, organophosphonium compounds, and organoimidazolium compounds are preferable. In terms of heat resistance, organophosphonium compounds and organoimidazolium compounds are particularly preferable.

The organophosphonium compound is represented by the following Structural Formula (I).

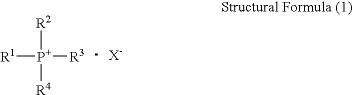

In the Structural Formula (I), R¹, R², R³, or R⁴ may be the same to or different from each other, and respectively represent ant one selected from hydrogen atoms, alkyl groups having 1 to 20 carbon atoms, and hydrocarbon groups including carboxyl groups, hydroxyl groups, phenyl groups, and epoxy groups; in the alkyl groups and phenyl groups, part of a hydrogen atom may be substituted by any one selected from a halogen atom, a hydroxyl group, a carboxyl group, and —COOR⁵ (where R⁵ represents an alkyl group having 1 to 5 carbon atoms).

X⁻ represents a counter ion, and examples thereof include halogen ions, acetate ions, and sulfate ions.

Examples of the organophosphonium compound represented by the Structural Formula (I) include hexadecyltriphenylphosphonium bromide, hexadecyltributylphosphonium bromide, and [10-(3,5-bismethoxycarbonylphenoxy)decyl]tributylphosphonium bromide.

Examples of the organoimidazolium compound include hexadecylimidazolium bromide, 1-methyl-3-[2-(3-pentadecylphenoxy)ethyl]imidazolium bromide, and [10-(3,5-bismethoxycarbonylphenoxy)decyl]-1-methylimidazolium bromide.

Preferred examples of the organohydroxy compound include alcohols having 1 to 20 carbon atoms. Examples of the alcohols having 1 to 20 carbon atoms include methyl alcohol, ethyl alcohol, propyl alcohol butyl alcohol, hexyl alcohol, octyl alcohol, cyclohexanol, and benzyl alcohol.

Examples of the organohalogen compound include halogenohydrocarbon groups having 1 to 20 carbon atoms such as methyl chloride, ethyl chloride, propyl chloride, butyl chloride, hexyl chloride, octyl chloride, cyclohexyl chloride, benzyl chloride or corresponding fluorides, bromides and iodides.

The organosilane compound is preferably, for example, a compound represented by the general formula, R⁶ₙSiX₄₋ₙ (wherein R⁶ represents a hydrocarbon group; X is a halogen atom, an OR⁷ group (wherein R⁷ represents an alkyl group) or an OH group, “n” is an integer of 1 to 3). Examples thereof include trimethylchlorosilane, diethyldichlorosilane, phenyltrichlorosilane, methylphenyldichlorosilane, vinyltrichlorosilane, phenylsilanol, trimethylethoxysilane, and phenyltriethoxysilane.

### —Solvent—

The solvent is used to obtain a dispersion liquid prepared by dissolving or suspending the layered silicate and a surface treatment agent and organically modifying the layered silicate with the surface treatment agent.

The solvent is not particularly limited, and can be appropriately selected depending on the purpose. Examples thereof include water, acetone, methyl alcohol, ethyl alcohol, isopropyl alcohol, and tetrahydrofuran (THF). These may be used alone or in combination.

The amount of layered silicate to be added in the solvent is preferably 0.1% by mass to 8% by mass. When the additive amount of the layered silicate is less than 0.1% by mass, it may be difficult to improve the dispersibility of the layered silicate, and the productivity may possibly degrade because of the small amount of yield in one production process. When the additive amount of the layered silicate is more than 4% by mass, gelation easily takes place in the solvent, and the dispersibility may possibly degrade.

It is preferable that the solution viscosity of the dispersion liquid immediately before being organically modified be stable to be from 2.0 mPa·s to 1,000 mPa·s, and more preferably from 2.5 mPa·s to 600 mPa·s. Here, the wording “be stable” means a state where the variation of solution viscosity after a certain period of time is within the range of ±10%. When the solution viscosity of the dispersion liquid is lower than 2.0 mPa·s, whether the solution viscosity is in a stable state or not may not be determined because the solution viscosity of the dispersion liquid is almost equal to the solution viscosity of a crude solvent used, and the productivity may degrade because the concentration of the layered silicate in the dispersion liquid is excessively low. When the solution viscosity of the dispersion liquid is higher than 1,000 mPa·s and even when a surface treatment agent or a solution prepared by previously dissolving a surface treatment agent in a solvent is added to the layered silicate, the silicate cannot be uniformly dispersed in the solution, and the layered silicate is not uniformly organically modified. Further, after the layered silicate is organically modified, filtered, washed, freeze-dried in vacuo and then dispersed in a thermoplastic resin, large aggregates of particles having a particle diameter greater than 20 μm may possibly take place.

Note that the solution viscosity can be measured, for example, by using a B-type viscometer (VISMETRON VS-A1, manufactured by SHIBAURA SYSTEMS CO., LTD.) at a temperature of 22° C.

The additive amount of the surface treatment agent is such an amount that the pH of the layered silicate dispersion liquid in which the layered silicate is dispersed in a solvent reaches 5 to 7. Usually, the pH of a dispersion liquid in which layered silicate is dispersed in a solvent is 9 or more and the dispersion has an alkaline pH. This is because alkali metals or alkali earth metals contained in the layered silicate are eluted in the dispersion liquid. Therefore, the addition of a surface treatment agent to the dispersion liquid until the pH of the dispersion liquid becomes neutral ensures that a sufficient amount of ions is exchanged to the cation exchange capacity (CEC) of the layered silicate. However, even when a sufficient amount of alkali metals or alkali earth metals existing between layers of layered silicate is exchanged, there exist hydroxy groups and the like on side surfaces of layered silicate. These hydroxyl groups on side surfaces hydrogen-bonded to one another to considerably expand the dispersion size of the layered silicate that has been dried. Therefore, it is necessary to add a surface treatment agent until the pH of the dispersion liquid reaches 7 or lower, where the dispersion liquid becomes acidulous and so that hydroxyl groups on side surfaces of the layered silicates adsorb the surface treatment agent to thereby prevent hydrogen-bonding between the hydroxyl groups on side surfaces. On the other hand, when the pH of the dispersion liquid is less than 5, an excess amount of the surface treatment agent is liable to remain on the surface of the layered silicate, which may stain a resin when the dried layered silicate is dispersed in the resin.

The method for dissolving or suspending layered silicate and a surface treatment agent in the solvent is not particularly limited, and can be appropriately selected from commonly used methods depending on the purpose. For example, it is preferable to use a high-shear pulverizer such as a bead mill, in addition to those using a blade type stirrer such as a magnetic stirrer and a homogenizer.

### —Vacuum Freeze-Drying Process—

In the vacuum freeze-drying process, the undried organically modified layered silicate after being washed is freeze-dried in vacuo at a temperature of −30° C. or lower. Specifically, it is preferable that a solution or paste obtained by dissolving and suspending layered silicate and a surface treatment agent in an appropriate solvent to prepare an organically modified layered silicate dispersion liquid, filtering the layered silicate dispersion liquid to obtain an organically modified layered silicate and washing the organically modified layered silicate be freeze-dried at a temperature of −30° C. or lower within one hour, and it is more preferable that the solution or paste be freeze-dried at a temperature of −50° C. within one hour. When the temperature is higher than −30° C., the organically modified layered silicate that has been dispersed in the freeze-drying process is oriented to cause an aggregation of particles. When the temperature is −30° C. or lower, the dispersed state can be maintained.

The method of dissolving and suspending layered silicate and a surface treatment in a solvent to react them and the method of filtering and washing the obtained organically modified layered silicate are not particularly limited, and known methods in the art may be employed.

The pressure at which the dispersion liquid is dried in vacuo is not particularly limited as long as it is such a pressure at which the solvent used can be removed to some degree and the dispersion liquid can be brought into a vacuum state, and is preferably 3.3 Pa to 26.6 Pa.

Furthermore, the dispersion liquid is preferably subjected to secondary drying after the vacuum freeze-drying in terms of completely removing the solvent used.

The temperature at which the freeze-dried layered silicate is secondarily dried is preferably 20° C. to 50° C., and the pressure at which secondary drying carried out is preferably 9.9 Pa to 40 Pa.

### (Resin Composition)

The resin composition of the present invention contains a thermoplastic resin and an organically modified layered silicate of the present invention, and further contains other components as required.

### —Thermoplastic Resin—

The thermoplastic resin is not particularly limited, can be appropriately selected depending on the purpose, and preferred examples thereof include polyester (for example, polyethylene terephthalate, polyethylene-2,6-naphthalate, polybutylene terephthalate, polycarbonate, and polyethylene terephthalate obtained by copolymerization of a monomer having as a substituent at least any one of an amide group and a sulfonate group), polypropylene, polyethylene, cycloolefin, and an acrylic resin. These may be used alone or in combination. Among these, polyethylene terephthalate (otherwise referred to as “PET”), polyethylene naphthalate, polycarbonate (otherwise referred to as “PC”), polymethylmethacrylate, and polyethylene terephthalate obtained by copolymerization of a monomer having as a substituent at least any one of an amide group and a sulfonate group are particularly preferable in terms that they are excellent in transparency.

The polyethylene terephthalate formed by copolymerization of a monomer having as a substituent at least any one of an amide group and a sulfonate group may be obtained by substituting part of the dicarboxylic acid component and/or part of the diol component with the following monomer. Examples of the monomer used include, 5-sodium dimethylsulfoisophthtalate, N,N-bis(3-aminopropyl)piperazine, N,N-bis(aminocyclohexyl)methane, 2-aminoethylpiperazine, 2-aminopropylpiperazine, diethanollaurate amide, o-aminobenzylalcohol, and m-xylenediamine. The amount of the dicarboxylic acid component and/or the diol component substituted by any one of these monomers is preferably 5 mol % or more. When the substitution amount of the dicarboxylic acid component and/or the diol component is less than 5 mol %, the dispersibility of inorganic fillers may be possibly insufficient.

The polyethylene terephthalate obtained by copolymerization of a monomer having as a substituent at least any one of an amide group and a sulfonate group may be used in combination with polyethylene phthalate or the like. When polyethylene phthalate is used in combination, the amount of the polyethylene terephthalate obtained by copolymerization of a monomer having as a substituent at least any one of an amide group and a sulfonate group is preferably 5 parts by mass to 25 parts by mass per 100 parts by mass of the resin components. When the amount of the polyethylene terephthalate is less than 5 parts by mass, the dispersibility may be possibly insufficient. When it is more than 25 parts by mass, the mechanical strength of the resulting resin composition may be possibly insufficient.

The additive amount of the thermoplastic resin in the resin composition is preferably 70 parts by mass to 99.5 parts by mass per 100 parts by mass of the resin composition. When the additive amount of the thermoplastic resin is less than 70 parts by mass, the dispersibility of inorganic particles and the transparency of the resulting resin composition may possibly degrade, and molded articles prepared using the resin composition may become sometimes too brittle to be used practically, and when it is more than 99.5 parts by mass, the mechanical strength may not be improved.

The amount of the organically modified layered silicate added to the resin composition is preferably 0.5 parts by mass to 30 parts by mass per 100 parts by mass of the resin composition. When the additive amount of the organically modified layered silicate is less than 0.5 parts by mass, the mechanical strength may not be improved, and when it is more than 30 parts by mass, the dispersibility and optical transparency of the resin composition may sometimes degrade, and molded articles prepared using the resin composition may sometimes become too brittle to be used practically.

The method for adding and mixing the organically modified layered silicate is not particularly limited, can be appropriately selected from commonly used methods, and it is preferable that the organically modified layered silicate be melt-kneaded by a melt-kneading method

The kneader used for melt-kneading organically modified layered silicate is not particularly limited, can be appropriately selected from commonly used kneaders depending on the purpose. Examples thereof include uniaxial extruders, same direction biaxial extruders, different direction biaxial extruders, a mortar-type continuous kneader (KCK) in which the kneading is carried out between a rotating disc and a stationary disc, BANBURY mixers, and roll mills.

Note that a resin composition obtained by a melt-kneading method may be previously dried in vacuo or by hot air heating upon subjecting it to extrusion molding or injection molding.

### —Other Additives—

Commonly used other additives may be used in combination with the resin composition within the range where the use amount of the additives does not impair the optical transparency and mechanical strength of the resin composition.

Examples of the additives include antioxidants, light stabilizers, thermal stabilizers, plasticizers, flame retardants, cross-linkers, antistatic additives, and compatibilization agents (such as a polyester copolymer obtained by copolymerization of a monomer having as a substituent an amide group and/or a sulfonate group).

The resin composition may be used as molded articles, films, and sheets by being formed and shaped by a commonly used forming method. Particularly, films and sheets can be used in an unstretched state or in a stretched state where they are stretched by uniaxial stretching or biaxial stretching.

Since the resin composition of the present invention contains the organically modified layered silicate of the present invention, it is excellent in mechanical strength, dimensional stability, gas barrier property, and optical transparency, can be used for various applications, and can be suitably used in various molded articles, for example, optical films, optical sheets, magnetic material supports, and supports for image forming materials.

The present invention can solve the prior art problems, and can provide an organically modified layered silicate that can prevent aggregation caused when expandable silicate is organically modified as well as can reduce the dispersion size of aggregates of particles caused when the organically modified layered silicate is added in a thermoplastic resin or the like, a method for producing an organically modified layered silicate, and a resin composition containing the organically modified layered silicate of which the mechanical strength, dimensional stability, optical transparency, and gas barrier property thereof are improved in balance.

### EXAMPLES

Hereafter, the present invention will be further described in detail referring to specific Examples, however, the present invention is not limited to the disclosed Examples.

### Example 1

### Preparation of Fine Particle 1

As an expandable layered silicate, 4 g of SOMASIF ME-100 (manufactured by CO-OP Chemical Co., Ltd., synthetic mica) was used and dispersed in 400 ml of water at a water temperature of 22° C. using a homogenizer (a blade type stirrer, manufactured by Nihonseiki Kaisha Ltd.) at 11,000 rpm, the agitation was stopped once to measure the solution viscosity of the expandable silicate aqueous solution in a warm bath of 22° C. using a B-type viscometer, and then the agitation was continued until the solution viscosity of the expandable silicate aqueous solution reached a constant value of 2.8 mPa·s. At this point where the solution viscosity of the expandable silicate aqueous solution was constant, a 10% by mass aqueous solution of hexadecyltriphenylphosphonium bromide (hexadecyltriphenylphosphonium ions) that had been previously prepared, as a surface treatment agent, by dissolving hexadecyltriphenylphosphonium bromide in water with stirring was added to the expandable silicate aqueous solution at a dropping rate of 0.2 mL/min until the pH of the solution reached approximately 6, and thereby the expandable layered silicate was organically modified (ion-exchanged) to obtain an organically modified layered silicate dispersion liquid.

The organically modified layered silicate dispersion liquid was washed with water while subjecting it to suction filtration by a Buchner funnel until the conductivity of the filtrate reached 200 μS/cm to obtain a paste of the organically modified layered silicate.

The thus obtained paste of the organically modified layered silicate was rapidly frozen in liquid nitrogen using a freeze dryer (TRIO MASTER IIA-04, manufactured by Kyowa Vacuum Engineering, LTD.) to stabilize the dispersed state. The frozen paste was put in a freeze drying apparatus that had been cooled to −30° C. or lower, and the pressure was reduced to 6.6 Pa to remove 90% of the solvent in the frozen paste of the organically modified layered silicate. At this time, the drying process was carried out under reduced pressure while cooling the sample such that the temperature of the sample exceeded the temperature at which the sublimation of the solvent was prevented. Subsequently, the pressure of the system was reduced to 13.3 Pa and maintained while adjusting the freeze drying apparatus so that the temperature of the sample was kept 30° C., then the reduction of pressure was once stopped and the reduction of pressure was completed at the time when the solvent was sublimated from the sample and the degree of pressure decrease did not fall. Through the above processes, fine particles 1 were prepared.

### Examples 2 to 9 and Comparative Examples 1 to 4

### Preparation of Fine Particles 2 to 13

Fine particles 2 to 13 were prepared in the same manner as in Preparation of fine particles 1, except that the type of expandable layered silicate, the type of surface treatment agent, a stable solution viscosity of the dispersion liquid obtained after expandable layered silicate was dissolved in a solvent, pH and drying conditions were varied as shown in Tables 1 and 2.

The solution viscosity in each preparation process of fine particles, the pH, and the particle size of dried fine particles 1 to 13 were measured as follows. The results are shown in Tables 1 and 2.

### <Measurement of Solution Viscosity>

The solution viscosity was measured using a B-type viscometer (VISMETRON VS-A1, manufactured by SHIBAURA SYSTEMS CO., LTD.), with a rotating shaft being changed according to the range of viscosity measured, in a warm bath of 22° C.

<Measurement of pH>

Using a pH meter (PH5011A, manufactured by CUSTOM Co., Ltd.), the pH in a reactor was measured with time.

### <Measurement of Size of Dried Particle>

The sample subjected to vacuum freeze-drying was pulverized at a pressure of 5 kgf, and observed by an electron microscope, and the size of dried particles was evaluated based on the following criteria.

### [Evaluation Criteria]

B: No aggregates of particles having a size larger than 100 μm were observed.

C: Aggregates of particles having a size larger than 100 μm were observed.

TABLE 1

| | | Swellable layered silicate | | Surface treating agent | | | |
|---|---|---|---|---|---|---|---|
| | Fine particle | Type | Amount (g) | Type | Amount (g) *1 | Solvent | pH |
| Ex. 1 | Fine particles 1 | Synthetic mica | 4 | Hexadecyltriphenyl- | 5 | Water | 6.2 |
| | | | | phosphonium bromide | | | |
| Ex. 2 | Fine particles 2 | Synthetic | 4 | Hexadecyltriphenyl- | 4 | Water | 6.8 |
| | | smectite | | phosphonium bromide | | | |
| Ex. 3 | Fine particles 3 | Synthetic mica | 4 | Hexadecyltributyl- | 5 | Water | 6.5 |
| | | | | phosphonium bromide | | | |
| Ex. 4 | Fine particles 4 | Synthetic mica | 4 | Hexadecyltriphenyl- | 4 | Solvent 1 | 5.7 |
| | | | | phosphonium bromide | | | |
| Ex. 5 | Fine particles 5 | Synthetic mica | 4 | [10-(3,5-bismethoxycarbonylphenoxy)- | 5.5 | Water | 6.5 |
| | | | | decyl]tributylphosphonium bromide | | | |
| Ex. 6 | Fine particles 6 | Synthetic | 4 | Hexadecyltriphenyl- | 5 | Solvent 1 | 6.5 |
| | | smectite | | phosphonium bromide | | | |
| Ex. 7 | Fine particles 7 | Synthetic mica | 4 | [10-(3,5-bismethoxycarbonylphenoxy)- | 5 | Water | 6 |
| | | | | decyl]-1-methylimidazolium bromide | | | |
| Ex. 8 | Fine particles 8 | Synthetic mica | 7 | Hexadecyltriphenyl- | 8.8 | Water | 6 |
| | | | | phosphonium bromide | | | |
| Ex. 9 | Fine particles 9 | Synthetic mica | 4 | 1-methyl-3-[2-(3-pentadecylphenoxy)- | 5 | Water | 6 |
| | | | | ethyl]-imidazolium bromide | | | |
| Comp. Ex. 1 | Fine particles 10 | Synthetic mica | 4 | Hexadecyltriphenyl- | 2 | Water | 8.5 |
| | | | | phosphonium bromide | | | |
| Comp. Ex. 2 | Fine particles 11 | Synthetic mica | 4 | Hexadecyltriphenyl- | 20 | Water | 4.5 |
| | | | | phosphonium bromide | | | |
| Comp. Ex. 3 | Fine particles 12 | Synthetic mica | 1 | Hexadecyltriphenyl- | 1.2 | Water | 6 |
| | | | | phosphonium bromide | | | |
| Comp. Ex. 4 | Fine particles 13 | Synthetic mica | 9 | Hexadecyltriphenyl- | 10.8 | Water | 7.5 |
| | | | | phosphonium bromide | | | |

*1 Additive mass of a surface treatment agent calculated from the additive amount of the dispersion liquid at which the pH value of the dispersion reached a constant value indicated in the rightmost column.
* For synthetic mica, SOMASIF ME-100 (synthetic expandable mica, manufactured by CO-OP Chemical Co., Ltd.) was used.
* For synthetic smectite, LUCENTITE SWN (synthetic smectite, manufactured by CO-OP Chemical Co., Ltd.) was used.
* Solvent 1 is a solvent in which water is mixed with acetone at a mixture rate of 7:1 (water:acetone).

TABLE 2

| | | Conditions for drying | | | | |
|---|---|---|---|---|---|---|
| | | | | Drying step | | |
| | | Freezing step | | | Degree of | |
| | | Temp- | | Temp- | pressure | Size of |
| | | erature | Time | erature | reduction | dried |
| | Particles used | (° C.) | (min) | (° C.) | (Pa) | particle |
| Ex. 1 | Fine particles 1 | −196 | 5 | 30 | 6.6 | B |
| Ex. 2 | Fine particles 2 | −196 | 5 | 30 | 6.6 | B |
| Ex. 3 | Fine particles 3 | −196 | 5 | 30 | 6.6 | B |
| Ex. 4 | Fine particles 4 | −196 | 5 | 30 | 6.6 | B |
| Ex. 5 | Fine particles 5 | −196 | 5 | 30 | 6.6 | B |
| Ex. 6 | Fine particles 6 | −196 | 5 | 30 | 6.6 | B |
| Ex. 7 | Fine particles 7 | −196 | 5 | 30 | 6.6 | B |
| Ex. 8 | Fine particles 8 | −196 | 5 | 30 | 6.6 | B |
| Ex. 9 | Fine particles 9 | −196 | 5 | 30 | 6.6 | B |
| Comp. | Fine particles | −196 | 5 | 30 | 6.6 | C |
| Ex. 1 | 10 | | | | | |
| Comp. | Fine particles | −196 | 5 | 30 | 6.6 | C |
| Ex. 2 | 11 | | | | | |
| Comp. | Fine particles | −196 | 5 | 30 | 6.6 | C |
| Ex. 3 | 12 | | | | | |
| Comp. | Fine particles | −196 | 5 | 30 | 6.6 | C |
| Ex. 4 | 13 | | | | | |

### Example 10

### Preparation of Resin Composition

Into a twin screw extruder (TEM-37, manufactured by Toshiba Machine Co., Ltd.), 5% by mass of fine particles 1, 83% by mass of M-PET (polyethylene terephthalate (PET), manufactured by FUJIFILM Corporation, hereinafter referred to as “PET1”) as a thermoplastic resin, and 10% by mass of a polyethylene terephthalate copolymer obtained by copolymerization of 20% by mass of a monomer having as a substituent a sulfonate group (SSIA-PET, manufactured by FUJIFILM Corporation) were added and melt-kneaded by a melt-kneading method, thereby obtaining a resin composition of Example 1. The mixture was kneaded at a screw rotational speed of 150 rpm and at a temperature of 275° C.

The resin composition thus obtained was extrusion molded by a biaxial extruder (manufactured by TOYO SEIKI CO., LTD.) using a T-die at a temperature of 275° C. to prepare a sheet having a thickness of 150 μm.

The sheet having a thickness of 150 μm was stretched threefold in lengthwise direction and crosswise direction (3×3) longitudinal direction and threefold in transverse direction sequentially (stretching speed in each direction was 1.5 m/min) at a drawing temperature of 105° C., thereby preparing a biaxially-stretched film having a thickness of 17 μm.

### Examples 11 to 18 and Comparative Examples 5 to 8

### Preparation of Resin Composition

Resin compositions were prepared, and biaxially-stretched films were prepared using each of the obtained resin compositions in the same manner as in Example 10, except that the type and the additive amount of thermoplastic resin and the type and the additive amount of organically modified layered silicate were changed as shown in Table 3.

### —Evaluation—

Next, properties of the biaxially-stretched films produced using each of the resin compositions of Examples 10 to 18 and Comparative Examples 5 to 8 were evaluated as follows. The results are shown in Tables 3 and 4.

### (1) Measurement of Thickness, Number of Layers, Interlayer Distance, and Dispersion Particle Size of Organically Modified Layered Silicate

### <Layer Thickness>

Each of the threefold-stretched films (3×3 in lengthwise direction and crosswise direction) obtained from each of the resin compositions was cut out into a sample slice of 100 nm in thickness in cross section using a microtome, and the sample was observed by a transmission electron microscope (JEM-2010: 100 kV, manufactured by JEOL Ltd.) at 200,000-fold magnification. The thickness of layers of 100 particles was actually measured, and the average value was regarded as a layer thickness (nm).

### <Interlayer Distance>

Each of the threefold-stretched films (3×3 in lengthwise direction and crosswise direction) obtained from each of the resin compositions was frozen and pulverized to obtain a powder, and the powder was subjected to a wide-angle X-ray diffraction (apparatus: RINT TTRIII, manufactured by Rigaku Corporation) to calculate an interlayer distance (mm) from a diffraction angle of a peak corresponding to each (001) plane. As measurement conditions, the X-ray generation intensity was 50 kV-300 mA, the range of measurement (diffraction angle 2θ) was from 1° to 35°, and the scaning speed was 40°/min.

### <Number of Layers>

Number of layers was calculated by dividing a layer thickness measured according to the above method by the interlayer thickness.

### <Dispersion Particle Size>

Each of the threefold-stretched films (3×3 in lengthwise direction and crosswise direction) obtained from each of the resin compositions was precisely cut out into a sample slice in cross section using a microtome, and the sample was observed by an electron microscope (S-4700: 5 kV, manufactured by Hitachi, Ltd.) at 1,000-fold magnification and 3,000-fold magnification. The particle size (major axis) of 100 particles was actually measured, and the average value was regarded as a dispersion particle size (μm).

### (2) Tensile Modulus of Elasticity

Each of the threefold-stretched films (3×3 in lengthwise direction and crosswise direction) obtained from each of the resin compositions was subjected to a tension test using a TENSILON tester (STROGRAPH VE50, manufactured by TOYO SEIKI CO., LTD.) to determine a tensile modulus of elasticity. Similarly, a tensile modulus of elasticity of a film made of only PET without inorganic particles was determined. Then, how the tensile modulus of elasticity of a sheet of the film made of the resin composition was increased as compared to the tensile modulus of elasticity of the film made of only PET was calculated by percentage. The results were evaluated and classified into the following three levels.

### [Evaluation Criteria]

A . . . Improved 50% or more relative to the film made of only PET

B . . . Improved 20% or more and less than 50% relative to the film made of only PET

C . . . Improved less than 20% relative to the film made of only PET

### (3) Gas Barrier Property

The water vapor permeability rate of each of the threefold-stretched films (3×3 in lengthwise direction and crosswise direction) obtained from each of the resin compositions was measured by a water vapor permeability tester (L80-5000, manufactured by LYSSY Co., Ltd.), and evaluated based on the following criteria. Gas barrier property was measured at a temperature of 40° C. for 24 hours.

### [Evaluation Criteria]

B . . . Decreased 50% or more relative to the vapor permeability of the film made of only PET

C . . . Decreased less than 50% relative to the vapor permeability of the film made of only PET

### (4) Evaluation of Haze

The haze of each of the threefold-stretched films (3×3 in lengthwise direction and crosswise direction) obtained from each of the resin compositions was measured, with varying the setting position of sample in lengthwise direction for three times and crosswise direction for three times, by a turbidimeter (COLOR AND COLOR DIFFERENCE METER MODEL 1001DP, manufactured by NIPPON DENSHOKU INDUSTRIES CO., LTD.), and the average value was used for evaluation. To avoid influence on the haze depending on the shape of a sample surface, tritolylphosphate was added into a cell, and the haze was measured in a state where the sample was soaked in tritolylphosphate, and the results were evaluated based on the following criteria.

### [Evaluation Criteria]

B . . . The haze was less than 30%.

C . . . . The haze was more than 30%.

### (5) Overall Evaluation

From the evaluation results (1) to (4), the resin compositions were evaluated overall and classified into the following two levels.

### [Evaluation Criteria]

Excellent . . . All evaluation items were ranked as A or B

Poor . . . Some of evaluation items were not ranked as A nor B

TABLE 3

| | Thermoplastic | | Thermoplastic | | | | | | | | |
|---|---|---|---|---|---|---|---|---|---|---|---|
| | resin 1 | | resin 2 | | Organically modified layered silicate | | | | | | |
| | | Blended | | Blended | | | Blended | Thickness | | | Particle |
| | | amount | | amount | | | amount | of | | Interlayer | diameter in |
| | | (% by | | (% by | | | (% by | dispersion | Number | distance | dispersion |
| | Type | mass) | Type | mass) | Type | | mass) | (nm) | of layers | (nm) | (μm) |
| Ex. 10 | PET1 | 83 | SSIA-PET | 10 | Ex. 1 | Fine particle 1 | 7 | 45 | 20 | 2.2 | 11 |
| Ex. 11 | PET1 | 83 | SSIA-PET | 10 | Ex. 2 | Fine particle 2 | 7 | 56 | 22 | 2.5 | 15 |
| Ex. 12 | PEN | 83 | SSIA-PET | 10 | Ex. 3 | Fine particle 3 | 7 | 47 | 22 | 2.1 | 14 |
| Ex. 13 | PET1 | 83 | SSIA-PET | 10 | Ex. 4 | Fine particle 4 | 7 | 47 | 17 | 2.7 | 10 |
| Ex. 14 | PET1 | 83 | SSIA-PET | 10 | Ex. 5 | Fine particle 5 | 7 | 51 | 20 | 2.6 | 7 |
| Ex. 15 | PC | 83 | SSIA-PET | 10 | Ex. 6 | Fine particle 6 | 7 | 49 | 23 | 2.2 | 12 |
| Ex. 16 | PET1 | 83 | SSIA-PET | 10 | Ex. 7 | Fine particle 7 | 7 | 56 | 27 | 2.1 | 6 |
| Ex. 17 | PET1 | 83 | SSIA-PET | 10 | Ex. 8 | Fine particle 8 | 7 | 52 | 22 | 2.4 | 15 |
| Ex. 18 | PET1 | 83 | SSIA-PET | 10 | Ex. 9 | Fine particle 9 | 7 | 46 | 23 | 2.0 | 12 |
| Comp. | PET1 | 83 | SSIA-PET | 10 | Comp. | Fine particle 10 | 7 | 220 | 169 | 1.3 | 35 |
| Ex. 5 | | | | | Ex. 1 | | | | | | |
| Comp. | PET1 | 83 | SSIA-PET | 10 | Comp. | Fine particle 11 | 7 | 140 | 58 | 2.4 | 30 |
| Ex. 6 | | | | | Ex. 2 | | | | | | |
| Comp. | PET1 | 83 | SSIA-PET | 10 | Comp. | Fine particle 12 | 7 | 150 | 56 | 2.7 | 23 |
| Ex. 7 | | | | | Ex. 3 | | | | | | |
| Comp. | PET1 | 83 | SSIA-PET | 10 | Comp. | Fine particle 13 | 7 | 250 | 139 | 1.8 | 40 |
| Ex. 8 | | | | | Ex. 4 | | | | | | |

PET 1: Polyethylene terephthalate (M-PET, manufactured by FUJIFILM Corporation);
PC: Polycarbonate (H-3000, manufactured by Mitsubishi Engineering-Plastics Corporation);
PEN: Polyethylene-2,6-naphthalate (TN8065, manufactured by TEIJIN CHEMICALS LTD.)

TABLE 4

| | Gas | | | |
|---|---|---|---|---|
| | barrier | Modulus of elasticity | | Overall |
| | property | during elongation | Haze | evaluation |
| Ex. 10 | B | A | B | Excellent |
| Ex. 11 | B | B | B | Excellent |
| Ex. 12 | B | B | B | Excellent |
| Ex. 13 | B | B | B | Excellent |
| Ex. 14 | B | A | B | Excellent |
| Ex. 15 | B | B | B | Excellent |
| Ex. 16 | B | A | B | Excellent |
| Ex. 17 | B | B | B | Excellent |
| Ex. 18 | B | A | B | Excellent |
| Comp. Ex. 5 | C | C | B | Poor |
| Comp. Ex. 6 | A | C | B | Poor |
| Comp. Ex. 7 | B | C | C | Poor |
| Comp. Ex. 8 | B | C | B | Poor |

### INDUSTRIAL APPLICABILITY

Since an organically modified layered silicate of the present invention and a method for producing an organically modified layered silicate of the present invention can prevent aggregation of organically modified layered silicate caused when expandable silicate is organically modified as well as to reduce the dispersion size of aggregates of particles caused when the organically modified layered silicate is added in a thermoplastic resin or the like, they can be used in various applications.

Furthermore, since a resin composition of the present invention, which contains the organically modified layered silicate, is improved in its mechanical strength, dimensional stability, optical transparency and gas barrier property in a balanced manner, it can be suitably used in various molded articles, optical films, optical sheets, magnetic material supports, supports for image forming materials, and the like.

1. An organically modified layered silicate comprising:
a laminate composed of 3 to 60 layers of silicate that have been treated with a surface treatment agent in a dispersed state,
wherein the laminate has a thickness of 10 nm to 120 nm, and an interlayer distance of the layers of the surface-treated silicate constituting the laminate is 1.5 nm to 4.0 nm.

2. The organically modified layered silicate according to claim 1, wherein the average particle diameter of the laminate in a dispersed state is 0.01 μm to 30 μm.

3. The organically modified layered silicate according to claim 1, obtained by dispersing layered silicate in a solvent to prepare a dispersion liquid, adding a surface treatment agent into the dispersion liquid until the pH of the dispersion liquid reaches 5 to 7 to obtain an organically modified layered silicate dispersion liquid, filtering the layered silicate dispersion liquid to obtain an organically modified layered silicate, and washing the organically modified layered silicate.

4. The organically modified layered silicate according to claim 1, wherein the surface treatment agent is any one of an organophosphonium compound and an organoimidazolium compound.

5. A method for producing an organically modified layered silicate comprising:
dispersing layered silicate in a solvent to prepare a dispersion liquid,
adding a surface treatment agent into the dispersion liquid until the pH of the dispersion liquid reaches 5 to 7 to obtain an organically modified layered silicate dispersion liquid,
filtering the layered silicate dispersion liquid to obtain an organically modified layered silicate, and
washing the organically modified layered silicate.

6. The method for producing an organically modified layered silicate according to claim 5, further comprising:
drying the organically modified layered silicate after the filtration and washing.

7. The method for producing an organically modified layered silicate according to claim 5, further comprising:
freeze-drying the organically modified layered silicate in vacuo at a temperature of −30° C. or lower after the washing.

8. A resin composition comprising:
a thermoplastic resin, and
an organically modified layered silicate,
wherein the organically modified layered silicate comprises a laminate composed of 3 to 60 layers of silicate that have been treated with a surface treatment agent in a dispersed state, and
wherein the laminate has a thickness of 10 nm to 120 nm, and an interlayer distance of the layers of the surface-treated silicate constituting the laminate is 1.5 nm to 4.0 nm.

9. The resin composition according to claim 8,
wherein the thermoplastic resin is at least one selected from polyethylene terephthalate, polyethylene naphthalate, polycarbonate, polymethylmethacrylate, and polyethylene terephthalate obtained by copolymerization of a monomer having as a substituent at least any one of an amide group and a sulfonate group.
